(19) United States
(12) Patent Application Publication
(10) Pub. No.: US 2026/0163792 A1
(43) Pub. Date: Jun. 11, 2026

(54) WIRELESS ACCESS POINT AND REBOOT METHOD THEREOF

(71) Applicant: ASUSTeK COMPUTER INC., Taipei City (TW)

(72) Inventors: Cho-Jan Chen, Taipei City (TW); Ten-Long Dan, Taipei City (TW); Chang-Yi Shen, Taipei City (TW); Tsung-Jen Huang, Taipei City (TW)

(73) Assignee: ASUSTeK COMPUTER INC., Taipei City (TW)

(21) Appl. No.: 19/026,387

(22) Filed: Jan. 17, 2025

(30) Foreign Application Priority Data
Dec. 11, 2024 (TW) 113148269

(51) Int. Cl. H04L 41/069; H04L 41/0654; H04W 88/08

(52) U.S. Cl. CPC H04L 41/069; H04L 41/0654; H04W 88/08

(57) ABSTRACT

A wireless access point and a reboot method thereof are provided. The wireless access point includes a system. The system includes a system log. The system log includes a shutdown time point and a plurality of warm reboot conditions. The reboot method includes: after the wireless access point reboots due to a reboot reason, performing a time synchronization operation based on a network time protocol to obtain a current time point, and calculating a reboot consuming time according to the shutdown time point and the current time point; determining whether the reboot consuming time is less than a preset consuming time; when the reboot consuming time is not less than the preset consuming time, performing a relocation operation; when the reboot consuming time is less than the preset consuming time, determining whether the reboot reason is one of the warm reboot conditions; and when the reboot reason is one of the plurality of warm reboot conditions, not performing the relocation operation.

### CROSS-REFERENCE TO RELATED APPLICATION

This application claims the priority benefit of Taiwan application serial no. 113148269, filed on Dec. 11, 2024. The entirety of the above-mentioned patent application is hereby incorporated by reference herein and made a part of this specification.

### BACKGROUND

### Technical Field

The disclosure relates to a wireless access point (wireless AP), and in particular relates to a wireless access point and a reboot method thereof.

### Description of Related Art

After a wireless access point is rebooted, the wireless access point needs to re-perform some service functions (for example, perform a relocation operation). The cost of the service functions may depend on the use times. Therefore, how to avoid unnecessary services after reboot is one of the issues that those skilled in the art are concerned about.

### SUMMARY

The disclosure provides a wireless access point and a reboot method thereof, which may avoid unnecessary services after reboot to save usage cost.

The disclosure provides a reboot method for a wireless access point. The reboot method includes: after the wireless access point reboots due to a reboot reason, calculating a reboot consuming time according to a shutdown time point in a system log and a current time point; determining whether the reboot consuming time is less than a preset consuming time; if the reboot consuming time is less than the preset consuming time, determining whether the reboot reason is a warm reboot condition; and if the reboot reason is the warm reboot condition, not performing a relocation operation.

The disclosure further provides a wireless access point. The wireless access point includes a storage media and a processor. The processor is coupled to the storage media. The storage media stores a system log. After the wireless access point reboots, the processor calculates a reboot consuming time according to a shutdown time point in the system log and a current time point. The processor determines whether the reboot consuming time is less than a preset consuming time. If the reboot consuming time is less than the preset consuming time, the processor determining whether a reboot reason is a warm reboot condition. If the reboot reason is the warm reboot condition, the processor does not perform a relocation operation.

Based on the above, the wireless access point and the reboot method thereof provided in the disclosure can determine whether a relocation operation is required according to the reboot reason and the reboot consuming time, which can effectively reduce the usage cost.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic diagram of a wireless access point and electronic devices according to an embodiment of the disclosure.

FIG. 2 is a flow chart illustrating a reboot method according to an embodiment of the disclosure.

FIG. 3 is an operation timing diagram of a wireless access point according to an embodiment of the disclosure.

FIG. 4 is a flow chart illustrating a reboot method according to an embodiment of the disclosure.

### DESCRIPTION OF THE EMBODIMENTS

Some embodiments of the disclosure will be described in detail below with reference to the accompanying drawings. Reference numerals quoted in the following description will be regarded as the same or similar components when the same reference numerals appear in different drawings. The embodiments are merely a part of the disclosure and do not disclose all possible implementations of the disclosure. More precisely, the embodiments are only examples in the claims of the disclosure.

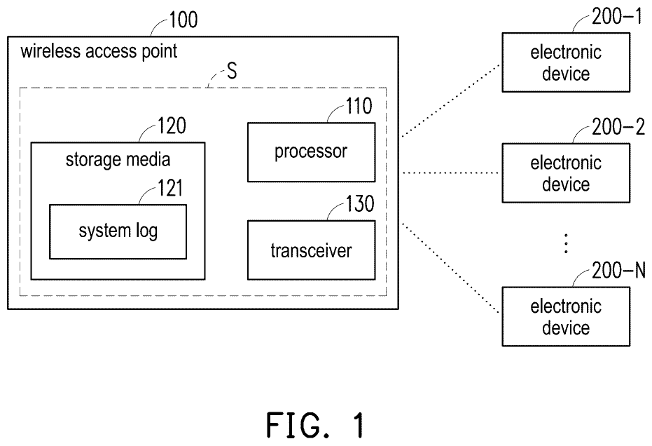

FIG. 1 is a schematic diagram of a wireless access point and electronic devices according to an embodiment of the disclosure. Please refer to FIG. 1. In this embodiment, the wireless access point 100 may be, for example a Wi-Fi access point (Wi-Fi AP), a wireless switch, a wireless router, or other device having an access point (AP) function. The electronic devices 200-1˜200-N may communicatively connect to the wireless access point 100 to access Internet and/or local network. Specifically, the wireless access point 100 communicatively connects to the electronic devices 200-1˜200-N and provides wireless access services for the electronic devices 200-1˜200-N. The wireless access services may include but are not limited to a wireless connection establishment procedure, a wireless connection maintenance procedure, a wireless connection release procedure, registration procedure, identity verification procedure, data package and/or signal transmission procedure, etc.

The wireless access point 100 includes a system S. The system S includes a system log 121. Specifically, the system S includes a processor 110, a storage media 120 and a transceiver 130. The storage media 120 is configured to store the system log 121. In an embodiment, system log 121 may include but is not limited to a shutdown time point and a plurality of warm reboot conditions.

The processor 110 may be, for example, a central processing unit (CPU), a micro control unit (MCU), a microprocessor, a digital signal processor (DSP), a programmable controller, a field programmable gate array (FPGA) or other similar elements or combinations of the above elements.

The storage media 120 may be, for example, a random access memory (RAM), a flash memory, a hard disk drive (HDD), a solid state drive (SSD) or similar elements or combinations of the above elements. The storage media 120 may store, for example, commands and/or data that can be accessed and performed by the processor 110.

The transceiver 130 may be, for example, each type of communication chip, a mobile communication chip, a Bluetooth chip, a Wi-Fi chip but is not limited thereto. The processor 110 is coupled to the storage media 120 and the transceiver 130.

The electronic devices 200-1˜200-N may be, for example, terminal devices with wireless transceiver functions, such as smart phones, tablet computers, desktop computers, and notebook computers respectively.

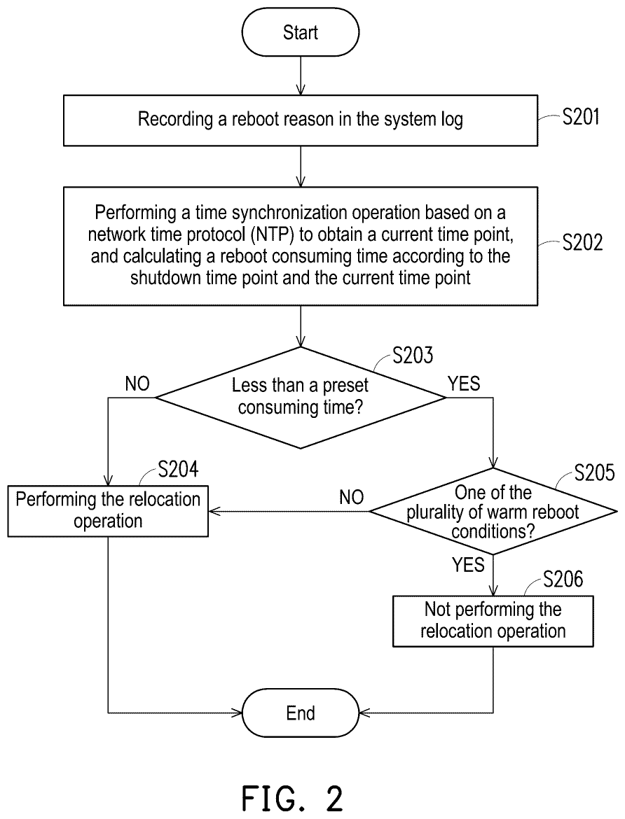

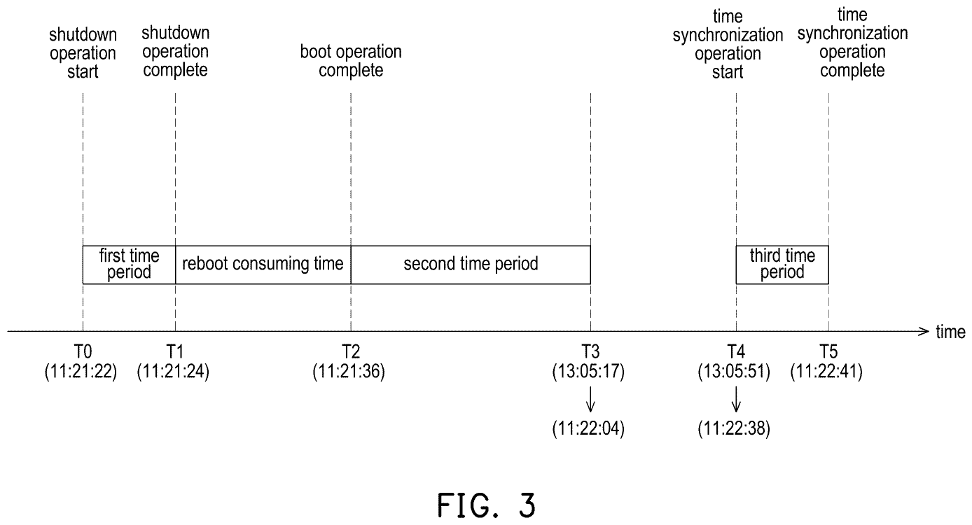

FIG. 2 is a flow chart illustrating a reboot method according to an embodiment of the disclosure. FIG. 3 is an operation timing diagram of a wireless access point according to an embodiment of the disclosure. Please refer to FIG. 1 to FIG. 3 simultaneously. In this embodiment, the wireless access point 100 can execute the reboot method shown in FIG. 2 to avoid performing unnecessary service functions, thereby saving usage cost.

In step S201, the processor 110 may record a reboot reason in the system log 121. In this embodiment, before the wireless access point 100 is rebooted, the processor 110 may record a reboot reason in the system log 121. Specifically, the processor 110 may record the operations performed by the wireless access point 100 (or the processor 110) and the corresponding time points in the system log 121. The processor 110 may perform a shutdown operation at time point T0 (e.g., 11:21:22) and record the reboot reason in the system log 121. Next, the processor 110 may complete the shutdown operation of the wireless access point 100 at time point T1 after a first time period (e.g., 2 seconds). The processor 110 may record the reboot reason and the time point T0 (i.e., the shutdown time point) at which the shutdown operation is started in the system log 121. It should be noted that the first time period is the time required for the shutdown operation, which may vary depending on the specifications and performance of the wireless access point 100.

In step S202, after the wireless access point 100 reboots due to the reboot reason, the processor 110 may perform a time synchronization operation based on a network time protocol (NTP) to obtain a current time point, and calculate a reboot consuming time according to the shutdown time point and the current time point. Specifically, since the wireless access point 100 is a plug-in electronic device, the wireless access point 100 does not have a battery and a real-time clock (RTC).

Therefore, after a boot operation, the wireless access point 100 needs to perform the time synchronization operation based on the network time protocol (NTP) to obtain a correct time point corresponding to the area where the wireless access point 100 belongs from a NTP server (not shown) (that is, the system time of the wireless access point 100 is synchronized to the current time point of the area where the wireless access point 100 belongs). That is to say, after the boot operation is completed and before the time synchronization operation is completed, the time points recorded in the system log 121 (i.e., time points T3 and T4) are not correct time points.

In this embodiment, the wireless access point 100 is rebooted at time point T2 (that is, the wireless access point 100 completes the boot operation at time point T2). Next, after a second time period (e.g., 28 seconds), the processor 110 may record the boot operation in the system log 121 at the time point T3. Specifically, the processor 110 may record the information associated with the completion of the boot operation and the time point T3 (e.g., 13:05:17) in the system log 121. It should be noted that, according to the actual use of the wireless access point 100, after the boot operation is completed (i.e., time point T2), the processor 110 needs to wait for the second time period before recording the information associated with the completion of the boot operation and the time point T3 (e.g., 13:05:17) in the system log 121, wherein the second time period may vary depending on the specifications and performance of the wireless access point 100.

Next, at time point T4 (e.g., 13:05:51), the processor 110 may perform the time synchronization operation based on a network time protocol (NTP), and record the information associated with the start of the time synchronization operation and the time point T4 in the system log 121. Afterwards, after a third time period (e.g., 3 seconds), the processor 110 may obtain the current time point (e.g., 11:22:41) at the time point T5, and record the information associated with the completion of the time synchronization operation and the current time point (i.e., time point T5) in the system log 121. It should be noted that the third time period is the time required for the time synchronization operation, which may vary depending on the specifications and performance of the wireless access point 100.

In this embodiment, the shutdown time point is the time point T0 (i.e., 11:21:22), and the current time point is the time point T5 (i.e., 11:21:41). The processor 110 may shift the time point T0 (i.e., 11:21:22) in the system log 121 back by the first time period (i.e., 2 seconds) to calculate the time point T1 as 11:21:24. In addition, the processor 110 may shift the time point T5 in the system log 121 back by the third time period (i.e., 3 seconds) to calculate the correct time point of the time point T4 as 11:22:38. Next, the processor 110 may calculate the correct time point of the time point T3 as 11:22:04 according to the correct time point of the time point T4 (i.e., 11:22:38), the time point T3 (i.e., 13:05:17) in the system log 121 and the time point T4 (i.e., 13:05:51) in the system log 121. Afterwards, the processor 110 may shift the correct time point of the time point T3 (i.e., 11:22:04) back by the second time period (i.e., 28 seconds) to calculate the time point T2 as 11:21:36. Accordingly, the processor 110 may calculate the reboot consuming time as 12 seconds according to the time point T1 (i.e., 11:21:24) and the time point T2 (i.e., 11:21:36).

In step S203, the processor 110 may determine whether the reboot consuming time is less than a preset consuming time. In this embodiment, the processor 110 may determine whether the reboot consuming time (i.e., 12 seconds) is less than a preset consuming time to determine whether a relocation operation is required. If the reboot consuming time is less than the preset consuming time, step S205 is proceeded. On the contrary, if the reboot consuming time is not less than the preset consuming time, step S204 is proceeded. The preset consuming time may be designed according to actual requirements, and is not limited by the disclosure.

In step S204, the processor 110 may perform the relocation operation to reacquire the location information. Specifically, if the reboot consuming time of the wireless access point 100 is too long (that is, the reboot consuming time is not less than the preset consuming time), the location information used in the previous reboot may not be usable any more. Therefore, after the wireless access point 100 is rebooted, the processor 110 needs to perform the relocation operation to reacquire the location information.

On the other hand, in step S205, the processor 110 may determine whether the reboot reason is one of the plurality of warm reboot conditions. In this embodiment, the processor 110 may further determine whether the reboot reason in the system log 121 is one of the plurality of warm reboot conditions to determine whether the relocation operation needs to be performed. Specifically, the reboot reason of the wireless access point 100 may be, for example, a warm reboot condition or a cold reboot condition.

In this embodiment, the plurality of warm reboot conditions may include but are not limited to a reboot after software crash, a scheduled reboot, a reboot after firmware update or a client reboot.

The reboot after software crash is, as the name implies, a reboot operation caused by a software crash. Generally, when the software crash occurs in the wireless access point 100, the wireless access point 100 will reboot to try to repair the software error.

The scheduled reboot is, for example, a reboot operation set by a user. For example, the user may configure the wireless access point 100 to perform the reboot operation at a specific time point through a web user interface (Web UI) (not shown) in a computer (e.g., electronic device 200-1) wirelessly connected to the wireless access point 100. For example, the user may configure the wireless access point 100 to perform the reboot operation at a specific time point through an application program (not shown) in a smart phone (e.g., electronic device 200-2) wirelessly connected to the wireless access point 100.

The reboot after firmware update is, as the name implies, a reboot operation performed after the firmware update is completed. Generally, when the wireless access point 100 completes the firmware update, the wireless access point 100 will automatically performs the reboot operation.

The client reboot is, for example, a reboot operation initiated by a user. For example, the user may initiate the reboot operation of the wireless access point 100 through the web user interface (not shown) in the computer (e.g., electronic device 200-1) wirelessly connected to the wireless access point 100. For example, the user may initiate the reboot operation of the wireless access point 100 through the application program (not shown) in the smart phone (e.g., electronic device 200-2) wirelessly connected to the wireless access point 100.

It should be noted that, in this embodiment, all reboot operations that are not caused by the warm reboot conditions are the reboot operations caused by the cold reboot conditions.

In this embodiment, if the reboot reason is not one of the plurality of warm reboot conditions mentioned above (i.e., the reboot reason is a cold reboot condition), return to step S204. That is to say, regardless of whether the reboot consuming time is too long (that is, regardless of whether the reboot consuming time is greater than the preset consuming time), as long as the reboot reason is a cold reboot condition, the processor 110 must perform the relocation operation after the reboot operation. On the contrary, if the reboot reason is one of the plurality of warm reboot conditions, step S206 is proceeded.

In step S206, the processor 110 does not perform the relocation operation. Specifically, if the reboot consuming time of the wireless access point 100 is shorter (i.e., the reboot consuming time is less than the preset consuming time) and the reboot reason is one of the plurality of warm reboot conditions mentioned above, the location information used in the previous reboot may continue to be used. Therefore, after the wireless access point 100 is rebooted, the processor 110 does not need to perform the relocation operation.

According to the above, the wireless access point 100 of the disclosure may record the reboot reason in the system log 121 before performing the reboot operation, and determine whether to perform the relocation operation according to the reboot consuming time and the reboot reason to avoid performing unnecessary relocation operation, thereby reducing usage cost.

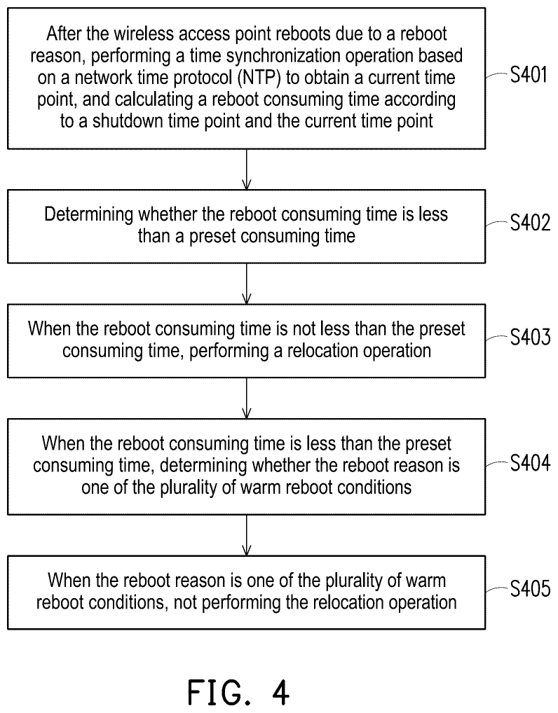

FIG. 4 is a flow chart illustrating a reboot method according to an embodiment of the disclosure, wherein the reboot method may be implemented by the wireless access point 100 as shown in FIG. 1. Please refer to FIG. 1 and FIG. 4. In step S401, after the wireless access point 100 reboots due to a reboot reason, performing a time synchronization operation based on a network time protocol (NTP) to obtain a current time point, and calculating a reboot consuming time according to a shutdown time point and the current time point. In step S402, determining whether the reboot consuming time is less than a preset consuming time. In step S403, when the reboot consuming time is not less than the preset consuming time, performing a relocation operation. In step S404, when the reboot consuming time is less than the preset consuming time, determining whether the reboot reason is one of the plurality of warm reboot conditions. In step S405, when the reboot reason is one of the plurality of warm reboot conditions, not performing the relocation operation.

To sum up, the wireless access point and the reboot method thereof provided by the embodiments of the disclosure may differentiate reboot reasons into the cold reboot conditions and the warm reboot conditions, record the reboot reason in the system log, and determine whether to perform the relocation operation according to the reboot reason and the reboot consuming time to avoid performing unnecessary functions, thereby effectively saving usage cost.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A reboot method, for a wireless access point, the wireless access point comprises a system, the system comprises a system log, and the system log comprises a shutdown time point and a plurality of warm reboot conditions, the reboot method comprising:
after the wireless access point reboots due to a reboot reason, performing a time synchronization operation based on a network time protocol (NTP) to obtain a current time point, and calculating a reboot consuming time according to the shutdown time point and the current time point;
determining whether the reboot consuming time is less than a preset consuming time;
when the reboot consuming time is not less than the preset consuming time, performing a relocation operation;
when the reboot consuming time is less than the preset consuming time, determining whether the reboot reason is one of the plurality of warm reboot conditions; and
when the reboot reason is one of the plurality of warm reboot conditions, not performing the relocation operation.

2. The reboot method according to claim 1, further comprising:
when the reboot reason is not one of the plurality of warm reboot conditions, performing the relocation operation.

3. The reboot method according to claim 1, wherein the plurality of warm reboot conditions comprises a reboot after software crash, a scheduled reboot, a reboot after firmware update or a client reboot.

4. The reboot method according to claim 1, further comprising:
before the wireless access point is rebooted, recording the reboot reason in the system log.

5. A wireless access point, where the wireless access point comprises a system, the system comprises a system log, and the system comprises:
a storage media, stores the system log, the system log comprises a shutdown time point and a plurality of warm reboot conditions; and
a processor, coupled to the storage media, and configured to:
after the wireless access point reboots due to a reboot reason, performing a time synchronization operation based on a network time protocol to obtain a current time point, and calculating a reboot consuming time according to the shutdown time point and the current time point;
determining whether the reboot consuming time is less than a preset consuming time;
when the reboot consuming time is not less than the preset consuming time, performing a relocation operation;
when the reboot consuming time is less than the preset consuming time, determining whether the reboot reason is one of the plurality of warm reboot conditions; and
when the reboot reason is one of the plurality of warm reboot conditions, not performing the relocation operation.

6. The wireless access point according to claim 5, wherein when the reboot reason is not one of the plurality of warm reboot conditions, the processor performs the relocation operation.

7. The wireless access point according to claim 5, wherein the plurality of warm reboot conditions comprises a reboot after software crash, a scheduled reboot, a reboot after firmware update or a client reboot.

8. The wireless access point according to claim 5, wherein before the wireless access point is rebooted, the processor records the reboot reason in the system log.
